(19) United States
(12) Patent Application Publication
(10) Pub. No.: US 2012/0284985 A1
(43) Pub. Date: Nov. 15, 2012

(54) Alignment Tool

(76) Inventor: Cataldo Proia, Rome, NY (US)

(21) Appl. No.: 13/540,025

(22) Filed: Jul. 2, 2012

Related U.S. Application Data
(63) Continuation-in-part of application No. 13/070,140, filed on Mar. 23, 2011.
(60) Provisional application No. 61/503,657, filed on Jul. 1, 2011.

(51) Int. Cl. B23Q 3/00; B23P 11/00

(52) U.S. Cl. 29/401.1; 269/287

(57) ABSTRACT

A tool used to maintain proper alignment and centering of the spring during retrofit operations (such as retrofit operations to create a self-steering axle. In most cases, four alignment tools, according to the present invention, are used to maintain spring/hanger alignment and centering during retrofit. More specifically, two springs (one at each end of the axle) must be held in alignment, and one tool is used at each longitudinal end of each spring, thereby making a total of four spring/hanger junctures where alignment must be established and maintained and a corresponding total of four tools to maintain this alignment. The tools are removed from the spring/hanger junctures when the retrofit is completed.

### RELATED APPLICATION

The present application claims priority to U.S. provisional patent application Ser. No. 61/503,657, filed on 1 Jul. 2011, and U.S. patent application Ser. No. 13/070,140, filed on 23 Mar. 2011 (published as publication number 20110248115 and herein referred to as “115 Proia”); all of the foregoing patent-related document(s) are hereby incorporated by reference herein in their respective entirety(ies).

### BACKGROUND OF THE INVENTION

1. Field of the Invention

The present invention relates to a tool used in performing retrofit operations on motor vehicle axle and suspension assemblies. Preferred retrofit operations are described in 115 Proia, and the purpose of these preferred retrofit operations is to convert a motor vehicle axle that does not pivot (in a horizontal plane (that is, a non-self-steering axle) into an axle that does pivot in a horizontal plane through some range of permitted angular motion (that is, a self-steering axle). One especially potential favorable application of these retrofit operations is to convert axles on trailers (pulled by tractor trailers) and/or trailer dolly sub-assemblies, and the tool of the present invention is believed to be especially advantageous in performing that specific type of retrofit operation.

2. Description of the Related Art

Good background information on self-steering axle assemblies and/or retrofit operations to create self-steering axle assemblies is set forth in 115 Proia; U.S. Pat. No. 5,220,972 (“972 Proia”) and/or U.S. Pat. No. 6,679,517 (“517 Proia”). The reader is especially referred to FIGS. 23A and 23B of 115 Proia because these show an important aspect of the retrofit that relates to the alignment tool of the present invention, to be discussed in subsequent sections of this document. Specifically, springs, like spring 269A of FIGS. 23A and 23B of 115 Proia must have some transverse direction clearance within the recesses in the hanger parts so that these springs can pivot in the horizontal plane about their vertical centerlines, so that the attached axle can pivot in a horizontal plane. This pivoting is shown (not necessarily to scale) in FIGS. 23A and 23B of 115 Proia. Even a relatively small range of pivoting motion of the spring (say, 3 degrees) can be very helpful in making effective and efficient self steering. Note the transverse direction clearance: (i) between spring 269A and hangar 238A; and (ii) between spring 269A and hanger 265A. This is the clearance that allows the pivoting of the spring and the axle mechanically connected to it.

### BRIEF SUMMARY OF THE INVENTION

The present invention recognizes that it is critical that, during retrofit operations, that the spring be precisely centered in the transverse direction relative to the hanger in which the spring rests. The spring must maintain its centering as retrofit work is performed on other parts of the self steering assembly, such as the axle, 45 degree brackets and the like (see 115 Proia). The springs (on at either end of the axle) cannot be allowed to pivot as the other work is being done because this leads to misalignment of the suspension system, which is highly unfavorable and requires correction until the springs (one at either end of the axle) are both properly aligned. To be more specific the longitudinal centerline of each spring must be: (i) centered in the hanger; and (ii) aligned with the forward/reverse direction (as defined by the vehicle or dolly frame).

The present invention is directed to a tool used to maintain proper alignment and centering of the spring during retrofit operations (such as retrofit operations to create a self-steering axle. In most cases, four alignment tools, according to the present invention, are used to maintain spring/hanger alignment and centering during retrofit. More specifically, two springs (one at each end of the axle) must be held in alignment, and one tool is used at each longitudinal end of each spring, thereby making a total of four spring/hanger junctures where alignment must be established and maintained and a corresponding total of four tools to maintain this alignment. The tools are removed from the spring/hanger junctures when the retrofit is completed.

Various embodiments of the present invention may exhibit one or more of the following objects, features and/or advantages:
(i) allows one-person retrofit operations for creating a self-steering axle; and
(ii) facilitates the creation of self-steering axles, which potentially leads, in turn to many other benefits such as improved fuel economy, better handling, fewer traffic accidents, reduced tire wear and so on.

According to an aspect of the present invention, an alignment tool is used with a hanger and a spring. The tool includes: an arm spacing structure (that defines a longitudinal direction and a transverse direction); a first arm structure; and a second arm structure. The first arm structure is rigidly mechanically connected to the arm spacing structure. The second arm structure is rigidly mechanically connected to the arm spacing structure so that it is spaced apart from the first arm structure. The first arm structure includes an outside facing surface and an inside facing surface. The second arm structure includes an outside facing surface and an inside facing surface. The first and second arms are structured, located and/or connected so that: (i) the inside facing surfaces of the first and second arms mutually oppose each other in a parallel spaced apart relationship, where the spacing is approximately equal to a width of the spring, and (ii) the outside facing surfaces of the first and second arms are both inclined with respect to the longitudinal direction such that the first and second arm structures are each narrower at their respective front ends than at their respective rear ends.

According to further aspect of the present invention, a retrofit of an axle assembly is performed. The axle assembly includes a spring and a hanger, with the hanger defining a spring-receiving recess. The method comprising the steps of: (i) providing an alignment tool having two arm structures; (ii) inserting the alignment tool into the spring-receiving recess of the hanger so that the arm structures of the alignment tool are disposed along opposing transverse edges of the spring so that a longitudinal centerline of the spring is centered in and aligned with the hanger; (iii) subsequent to the inserting step, retrofitting the axle assembly; and (iv) subsequent to the retrofitting step, removing the alignment tool from the spring receiving recess so that a longitudinal centerline of the spring remains centered in and aligned with the hanger.

### BRIEF DESCRIPTION OF THE DRAWINGS

The present invention will be more fully understood and appreciated by reading the following Detailed Description in conjunction with the accompanying drawings, in which:

FIG. 1A is an orthographic top view of a constituent part of a first embodiment of an alignment tool according to the present invention;

FIG. 1B is an orthographic rear end view of a constituent sub-assembly of the first embodiment alignment tool;

FIG. 1C is an orthographic top view of a constituent sub-assembly of the first embodiment alignment tool;

FIG. 1D is an orthographic right side view of the first embodiment alignment tool;

FIG. 1E is an orthographic top view of the first embodiment alignment tool;

FIG. 2A is an orthographic top exploded view of the first embodiment alignment tool;

FIG. 2B is a top orthographic view of the first embodiment alignment tool; and

FIG. 3 is a top orthographic view of the first embodiment alignment tool in place within a recess of a hanger member and placed around a spring member.

### DETAILED DESCRIPTION OF THE INVENTION

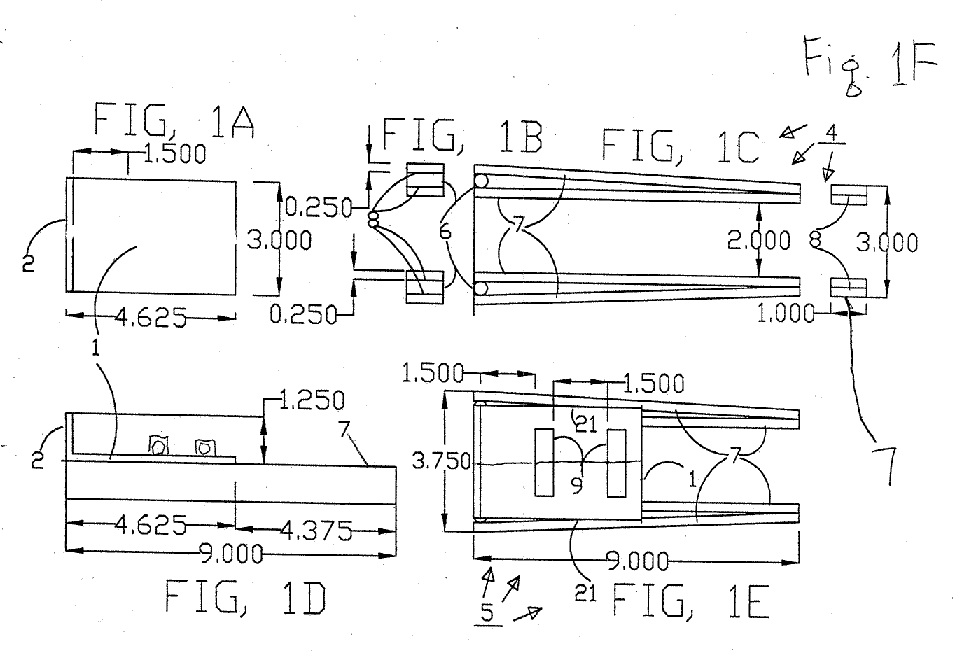

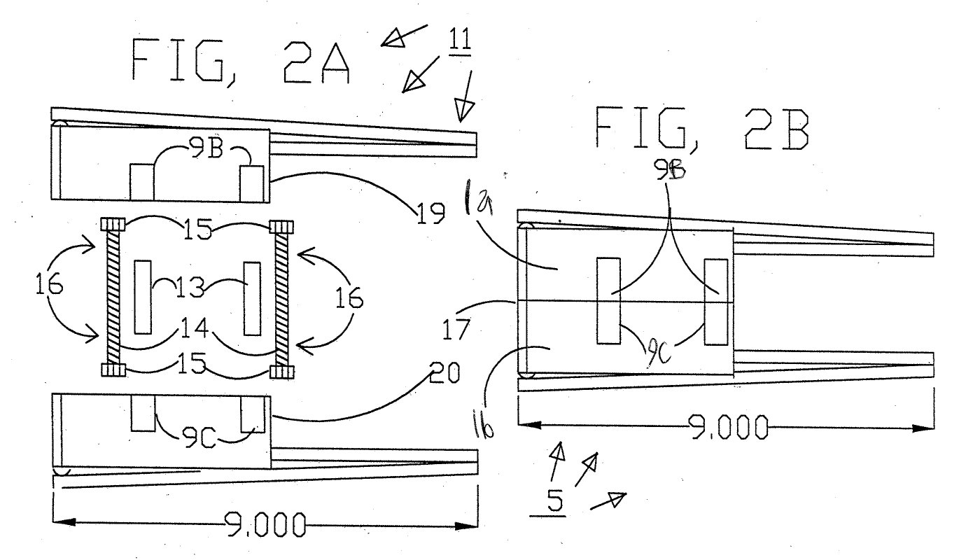

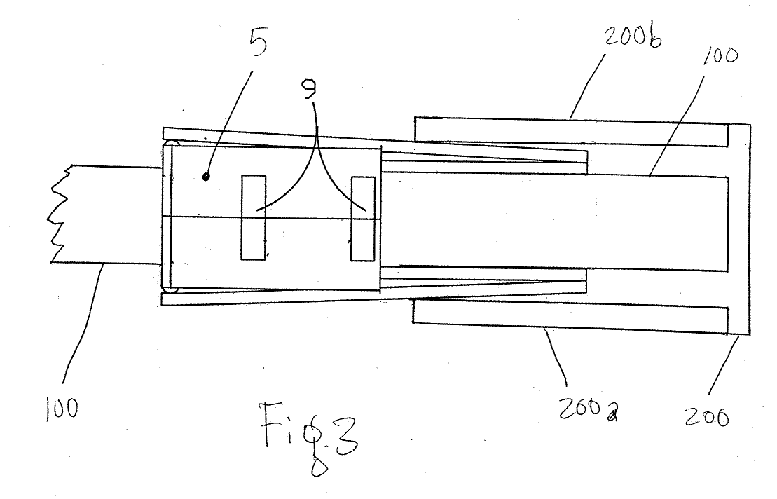

FIGS. 1A, 1B, 1C, 1D, 1F, 2A, 2B and 3 show various views of alignment tool 5 (the exploded view of the tool in FIG. 2A is labeled as view 11). Tool 5 includes: arm spacing members 1 (including left arm spacing member 1a and right arm spacing member 1b); bent portions 2; arms sub-assembly 4; tubular portions 9 (including left halves 9B and right halves 9C); brake lining tubes 13; threaded members 14 (including end portions 16); octagonal shape nuts 15; centerline cut 17; and welded edge 21. Arms sub-assembly 4 includes: dowel members 6; four arm members 7; and junction portion 8. As shown in FIG. 3, the alignment tool is used in conjunction with a hanger 200 (including guide portions 200a and 200b); and spring 100. Hanger 200 and spring 100 are generally similar to the various hangers and springs shown in more detail in 115 Proia. While the present invention is not limited to tools designed for any one particular type of hanger member and/or any one particular type of spring, at least to some extent the dimensions of the tool will depend upon the dimensions of the spring design(s) and hanger design(s) with which the alignment tool is intended for use. Also, the alignment tool of the present invention will generally come in a set of four tools. This way both ends of two opposing springs can be held in alignment at the same time, as is generally required when performing retrofit operations on an axle. FIG. 3 shows one tool in place, but there would generally be three other tools in place at the same time as the retrofit operations are being performed.

Tool 5 is a specially designed tool for accurate and easy installation of all tandem or spring axle parts in retrofitting an axle to convert it into a self steering axle. Due to the fact that all manufactured items, such as suspension hangers, torque bars and springs (see, generally 115 Proia) have relatively loose tolerancing, achieving and maintaining good alignment of the axle (that is, perpendicular to the driving direction) and other parts is a very difficult challenge. However, alignment is critical because the wheels and tires that are attached to the axle must be well aligned for efficient and safe driving. While conversion of an axle to a self-steering axle can improve fuel economy and handling of a tractor trailer, or tandem tractor trailer, these improvements are defeated in their purpose if the axle ends up becoming misaligned through the retrofitting operation that creates it. With the tool of the present invention, good alignment can be reliably ensured through the retrofit. Furthermore, the tool of the present invention allows a single individual worker to perform the retrofit.

FIG. 1A shows a strike plate portion made up of arm spacer members 1. In FIG. 1A, tubular portions 9 have not yet been mechanically connected to members 1 and centerline cut 17 has not been made yet. FIG. 2A shows the arm spacer plates after the tubular portions have been mechanically connected to it and centerline cut en made to separate the strike plate into two precisely matching halves. Alternatively, the strike plate can be made as two separate piece parts. The tubular parts are preferably mechanically connected to the arm spacer members by welding.

FIGS. 1B, 1C and 1F show arms sub-assembly 4 which are made by connecting two pairs of arm members 7 as follows: (i) to each other at junction portion 8 at the front ends of each pair of arms; and (ii) to dowel member 6 and the rear ends of each pair of arms. The use of the dowel member allows for precise spacing and relative inclination in each pair of arm members. More specifically, both pairs of arm members should define the same angle so that the arms precisely center the longitudinal centerline of the spring (see FIG. 3) as the arms of the tool are forcer in the longitudinal direction into the transverse direction gaps between the edges of the hanger and the guide plates of the hanger. Dowel 6 and arm members 7 are preferably made from pre-cut metal. Junction 8 is preferably mechanically connected by welding. Preferably the front ends of the arm members should be ground to a taper.

Once each pair of arms is assembled, as described in the preceding paragraph, the arms need to be mechanically connected to each other, at a precise mutual distance and alignment, by the arm spacer members 1. As shown in FIG. 2A: (i) the rear end portion of the left side pair of arm members is welded to the bottom of arm spacer member 1a so that the inside arm member is parallel with the arm spacer member, but the outside arm member is at an acute angle to the edges of arm spacer member 1a; and (ii) the rear end portion of the right side pair of arm members is welded to the bottom of arm spacer member 1b so that the inside arm member is parallel with the arm spacer member, but the outside arm member is at an acute angle to the edges of arm spacer member 1a. Preferably, the welded connection between arm sub-assembly 4 and the strike plate should be limited to outside edges at item 21.

As best shown in FIG. 2A, brake lining tubes 13 are inserted over the central portions of threaded members 14 (for example, 4 inch long pieces of 5/16 inch redibolt). The threaded members and brake lining tubes are inserted through an aperture running thru tubular members 9. Nuts 15 are then treaded down onto both ends of both threaded members 14. This installation of the nuts at each end of the tubular member forces the halves of tubular portions 9B and 9C against each other as best shown in FIG. 9B. Loc-tite (or the like) is used to ensure that the two halves of the strike plate sub-assembly are held fast together by the securing of the tubular portions against each other. The nuts on item 15 should match the octagon flat areas. For clarity of illustration purposes, the orthogonal nuts are not shown in FIG. 2B, which shows alignment tool 5 in its fully assembled state and ready for use. Exemplary dimensions are given throughout the drawings, but these dimensions should not be considered as limiting, except to the extent that they are explicitly invoked in a claim in this document.

FIG. 3 shows tool 5 as inserted in place for a retrofit operation. As shown in FIG. 3, the front portions of the arms are inserted into the transverse gaps between 100 spring and the guide plates 200a, 200b of hanger 200. Because the exterior-facing arm members are inclined with respect to the driving direction, the arms will gradually force the spring to be centered and aligned within the hanger. Friction between tool 5, hanger 200 and spring 100 will hold the tool in place as the retrofit is performed. After the retrofit operations are completed, the four alignment tools 5 can be removed from the four ends of the two involved springs. When the tools are removed, the springs will be longitudinally aligned and transversely centered with excellent precision, thereby ensuring alignment of the axle and other self-steering related parts (see, generally, 115 Proia).

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

What is claimed is:

1. An alignment tool for use with a hanger and a spring, the tool comprising:
an arm spacing structure that defines a longitudinal direction and a transverse direction;
a first arm structure; and
a second arm structure;
wherein:
the first arm structure is rigidly mechanically connected to the arm spacing structure;
the second arm structure is rigidly mechanically connected to the arm spacing structure so that it is spaced apart from the first arm structure;
the first arm structure includes an outside facing surface and an inside facing surface;
the second arm structure includes an outside facing surface and an inside facing surface;
the first and second arms are structured, located and/or connected so that:
the inside facing surfaces of the first and second arms mutually oppose each other in a parallel spaced apart relationship, where the spacing is approximately equal to a width of the spring, and
the outside facing surfaces of the first and second arms are both inclined with respect to the longitudinal direction such that the first and second arm structures are each narrower at their respective front ends than at their respective rear ends.

2. The tool of claim 1 wherein:
the first arm structure comprises an outside facing plate having a front end and a rear end and an inside facing plate having a front end and a rear end;
the second arm structure comprises an outside facing plate having a front end and a rear end and an inside facing plate having a front end and a rear end;
the outside facing plate of the first arm structure includes the outside facing surface of the first arm structure;
the inside facing plate of the first arm structure includes the inside facing surface of the first arm structure;
the outside facing plate of the second arm structure includes the outside facing surface of the second arm structure;
the inside facing plate of the second arm structure includes the inside facing surface of the second arm structure;
the front ends of the inside facing plate and the outside facing plate of the first arm structure are in contact and oriented so that the outside facing plate is inclined relative to the inside facing plate; and
the front ends of the inside facing plate and the outside facing plate of the second arm structure are in contact and oriented so that the outside facing plate is inclined relative to the inside facing plate.

3. The tool of claim 2 wherein:
the first arm structure further comprises a dowel member;
the second arm structure further comprises a dowel member;
the dowel member of the first arm structure mechanically connects the rear ends of the inside facing plate and the outside facing plate of the first arm structure; and
the dowel member of the second arm structure mechanically connects the rear ends of the inside facing plate and the outside facing plate of the second arm structure.

4. The tool of claim 2 wherein:
the arm spacing structure is welded to one, and only one, of the following: the inside facing plate of the first arm structure and the outside facing plate of the first arm structure; and
the arm spacing structure is welded to one, and only one, of the following: the inside facing plate of the second arm structure and the outside facing plate of the second arm structure.

5. The tool of claim 1 wherein:
at least a portion of a top surface of the first arm structure is welded to a portion of a bottom surface of the arm spacing structure; and
at least a portion of a top surface of the second arm structure is welded to a portion of the bottom surface of the arm spacing structure.

6. A method of performing a retrofit of an axle assembly, with the axle assembly including a spring and a hanger, with the hanger defining a spring-receiving recess, the method comprising the steps of:
providing an alignment tool having two arm structures;
inserting the alignment tool into the spring-receiving recess of the hanger so that the arm structures of the alignment tool are disposed along opposing transverse edges of the spring so that a longitudinal centerline of the spring is centered in and aligned with the hanger;
subsequent to the inserting step, retrofitting the axle assembly; and
subsequent to the retrofitting step, removing the alignment tool from the spring receiving recess so that a longitudinal centerline of the spring remains centered in and aligned with the hanger.

7. The method of claim 6 wherein the retrofitting step is a retrofit to convert the axle assembly into a self-steering axle assembly.
